(19) United States
(12) Patent Application Publication
(10) Pub. No.: US 2005/0253102 A1
(43) Pub. Date: Nov. 17, 2005

(54) Faucet control device and associated method

(75) Inventor: Howard Boilen, Pleasantville, NY (US)

Correspondence Address: R. Neil Sudol, 714 Colorado Avenue, Bridgeport, CT, 06605-1601, US

(73) Assignee: Allstar Marketing Group, LLC, Hawthorne, NY (US)

(21) Appl. No.: 11/126,725

(22) Filed: May 11, 2005

Related U.S. Application Data
(60) Provisional application No. 60/570,599, filed on May 13, 2004.

(51) Int. Cl. F16K 31/02

(52) U.S. Cl. 251/129.04

(57) ABSTRACT

A water flow gating device for a sink includes a casing, an inlet port disposed on the casing and couplable to a faucet spout, a water outflow port on the casing, a valve disposed in the casing between the inlet port and the outflow port for controlling water flow from the inlet port to the outflow port, an ultrasonic sensor mounted to the casing, and a control circuit operatively connected to the sensor and the valve to control opening and closing of the valve in accordance with signals received from the sensor. The control circuit includes a program and associated hardware for calibrating the gating device in accordance with sink size.

### CROSS-REFERENCE TO RELATED APPLICATION

This application claims the benefit of U.S. Provisional Patent Application No. 60/570,599 filed May 13, 2004.

### BACKGROUND OF THE INVENTION

This invention relates to a switching device for remotely and automatically controlling the flow of water from a faucet.

Conventional switching devices are known for automatically controlling faucet operation in response to sensing the presence of a hand or other object in proximity to the faucet. These switching devices alternately enable and disable water flow so that the user need not touch a faucet handle during a hand washing procedure. Generally, such switching devices are disposed inside a sink cabinet or on a sink countertop and are operatively connected to the water feed lines extending to the faucet spigot or spout. U.S. Pat. No. 6,420,737 discloses a modular unit with an infrared sensor that is connectable to the free end of a waterspout or spigot for enabling an easy retrofit of existing sinks. A disadvantage of this modular unit is that it will not work as desired when a person wishes to wash an inanimate object. Such an object being at room temperature does not activate the infrared sensing function.

### OBJECTS OF THE INVENTION

It is an object of the present invention to provide an improved automatic faucet control or switching device.

Another object of the present invention is to provide an automatic faucet control or switching device of the retrofit type that enables water flow even where an inanimate object is inserted below a water outflow port.

A related object of the present invention is to provide an automatic faucet control or switching device of the retrofit type that enables water flow even where a room-temperature object is inserted below a water outflow port.

A further object of the present invention is to provide an automatic faucet control or switching device of the retrofit type that enables manual override.

It is an additional object of the present invention to provide an automatic faucet control or switching device of the retrofit type with a battery replace indicator.

Yet another object of the present invention is to provide an associated remote or automatic faucet control method.

These and other objects of the present invention will be apparent from the drawings and descriptions herein. Although every object of the invention is believed to be attained in at least one embodiment of the invention, there is not necessarily any one embodiment that achieves all of the objects of the invention.

### SUMMARY OF THE INVENTION

A water flow gating device for a sink comprises, in accordance with the present invention, a casing, an inlet port disposed on the casing and couplable to a faucet spout, a water outflow port on the casing, a valve disposed in the casing between the inlet port and the outflow port for controlling water flow from the inlet port to the outflow port, an ultrasonic sensor mounted to the casing, and a control circuit operatively connected to the sensor and the valve to control opening and closing of the valve in accordance with signals received from the sensor.

In accordance with another feature of the present invention, the control circuit includes a program and associated hardware for calibrating the gating device in accordance with sink size. Thus, once the device is attached to a sink spigot or waterspout, the control circuit is placed into a calibration mode for detecting the distance of the faucet or gating device to the sink bottom. Objects (e.g., hands or inanimate objects) placed in the sink within a certain range of distances from the sink bottom trigger the opening of the valve by the control circuit.

In accordance with a further feature of the present invention, a battery is provided in the casing, while the control circuit includes a subcircuit for detecting a low-power condition of the battery. The gating device further includes an electro-optical transducer operatively connected to subcircuit for emitting a predetermined alert signal upon the falling of the battery power to a predetermined

The control circuit of the gating device may include an integrated circuit programmed for distance calibration. The integrated circuit may be programmed to calculate a range of object distances for faucet activation.

A method for controlling water flow from a faucet spout comprises, in accordance with the present invention, connecting a modular control device to an outlet of the faucet spout, operating an ultrasonic sensor on the device to monitor a space between the control device and an underlying sink surface, and, upon detecting an object between the control device and the sink surface, operating a valve to permit water from the outlet to an outflow port on the control device.

Pursuant to another aspect of the present invention, the method further includes calibrating the control device to adapt the control device to the size of a particular sink. More specifically, the calibrating of the control device includes detecting a distance between the control device and the sink surface.

The calibrating of the control device may further include operating a programmed circuit in the control device to compute a minimum distance and a maximum distance of an operating range, the detecting of an object between the control device and the sink surface including detecting the object within the operating range.

The present invention provides an improved automatic faucet control or switching device of the retrofit type that enables water flow even where an inanimate or cool object is inserted below a water outflow port.

### BRIEF DESCRIPTION OF THE DRAWINGS

FIG. 1 is a perspective view of a water flow control device in accordance with the present invention, for retrofitting to an outlet of a faucet spigot or spout.

FIG. 2 is a side elevational view of the water flow control device of FIG. 1.

FIG. 3 is a top plan view of the water flow control device of FIGS. 1 and 2.

FIG. 4 is a circuit diagram of a control circuit of the water flow control device of FIGS. 1-3.

FIG. 5 is a flow chart diagram showing operational steps of a programmed integrated circuit included in the circuit of FIG. 4.

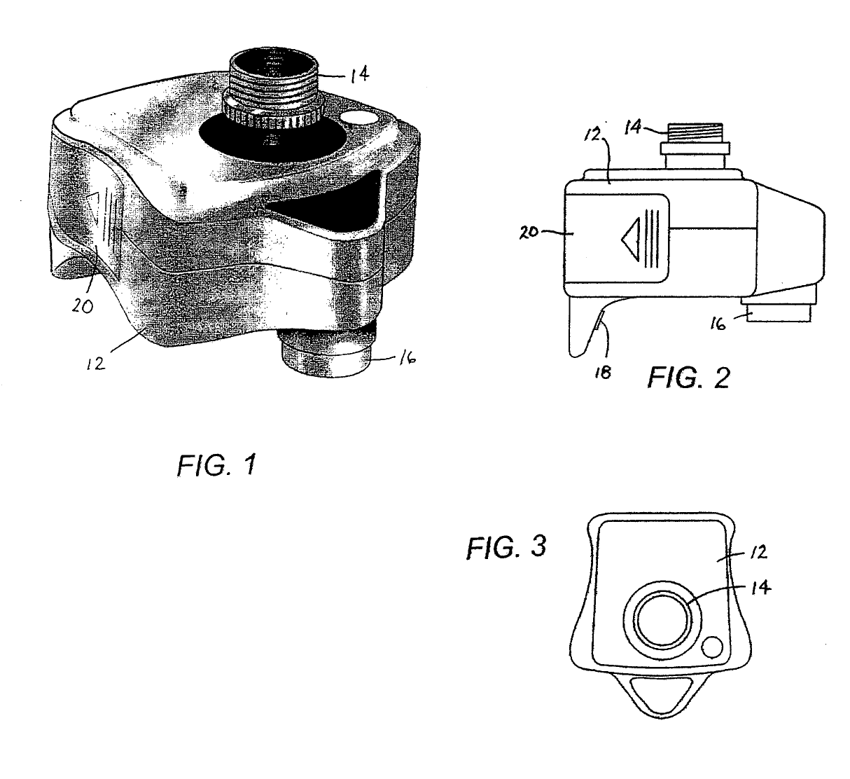

FIG. is a circuit diagram of an alternative control circuit of the water flow control device of FIGS. 1-3.

### DETAILED DESCRIPTION OF THE PREFERRED EMBODIMENTS

As illustrated in FIGS. 1-3, a water flow gating device for a sink faucet comprises a casing 12 provided on an upper side with an inlet port 14 having an external screw thread (not separately designated) for mating with an internal screw thread of a faucet spigot or spout outlet (not shown). Casing 12 is provided on a lower side with a water outflow port 16 and an ultrasonic sensor 18. On a lateral panel of casing 12 is disposed a slidable cover 20 for a battery compartment (not shown).

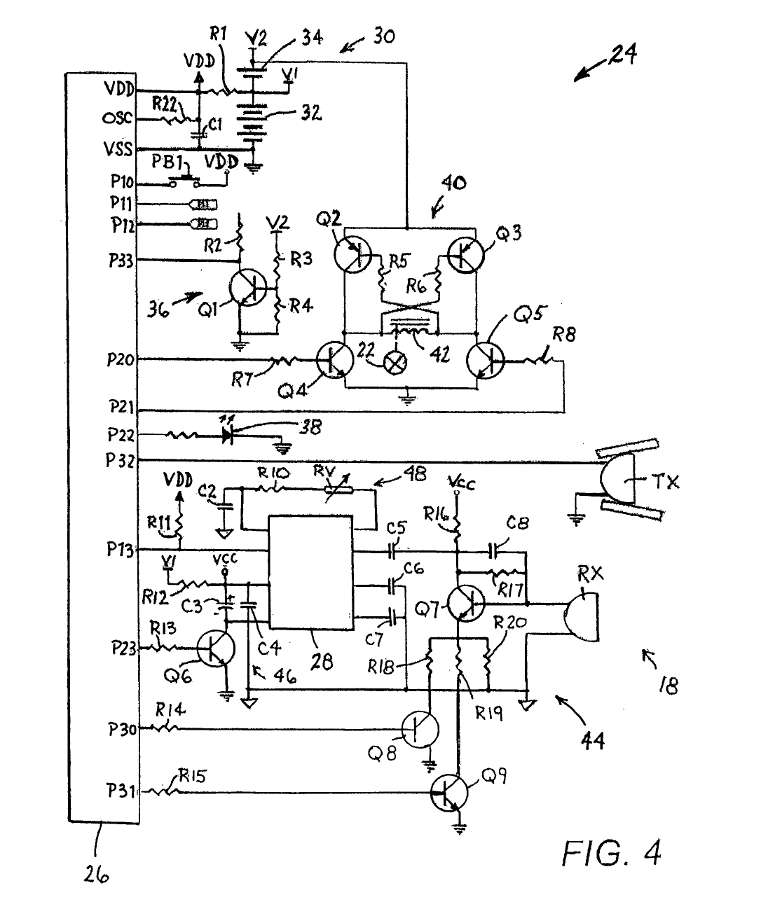

A valve 22 (schematically represented in FIG. 4) is disposed in casing 12 between inlet 14 port and outflow port 16 for controlling water flow from the inlet port to the outflow port. Also disposed in casing 12 is a control circuit 24 operatively connected to sensor 18 and valve 22 to control opening and closing of the valve in accordance with signals received from the sensor.

As depicted in FIG. 4, control circuit 24 comprises a primary integrated circuit (IC) 26 and a secondary IC 28. Primary control IC 26 specifically takes the form of EMC chip No. PN0242, while secondary IC 28 is National Semiconductor chip No. U2 LMC567. Primary IC 26 controls learning functions (determination of sink size), indicator activation and valve operation. Primary IC 26 also enables a manual bypass or override of the automatic flow control. Secondary IC 28 functions as a signal sampling circuit or preprocessor.

Control circuit 24 further comprises a voltage supply subcircuit 30 including batteries 32 and 34, a 51 Ω resistor R1, a 0.1 μF capacitor C1, and a 91 kΩ (±1%) second resistor R22 connected in the illustrated structure to terminals VDD, OSC and VSS of primary IC 26. Voltage supply circuit 30 provides a first voltage V1 of 4.5 volts, a second voltage V2 of 6.0 volts and voltage VDD (2.2-4.5 volts). Capacitor C1 and resistor R1 are connected in series across battery 32. Capacitor C1 is connected via resistor R22 to an oscillator input of IC 26, for enabling the generation of a 40 KHz waveform fed to an electroacoustic transducer TX. Transducer TX is a transmitting part of sensor 18 and incorporates a piezoelectric crystal. Sensor 18 further includes a receiving transducer RX that also incorporates a piezoelectric crystal.

Control circuit 24 also comprises a voltage monitoring subcircuit 36 operatively connected to voltage supply circuit 30 via IC 26 for monitoring the power level of at least battery 32. Subcircuit 30 includes a transistor Q1 (part #9014C) and resistors R2, R3, and R4 of 100 kΩ, 1 MΩ, and 150 kΩ, respectively. In response to a signal from subcircuit 36, primary IC 26 energizes a light-emitting diode (LED) 38 via a 100 Ω resistor R9 with a predetermined waveform (e.g., pulsating) to indicate a battery-weak condition.

Control circuit 26 additionally comprises a valve activation subcircuit 40 including a first pair of transistors Q2 and Q3 (parts #8550C) and a second pair of transistors Q4 and Q5 (parts #8050C) connected to a solenoid coil 42 in a bridge configuration including two 470 Ω resistors R5 and R6. Valve activation circuit 40 is connected to voltage supply subcircuit 30 for receiving voltage V2. Circuit 40 is connected to a valve-open terminal of primary IC 26 via a 1 kΩ resistor R7 and to a valve-close terminal of primary IC 26 via another 1 kΩ resistor R8. In response to a valve-open signal from IC 26, circuit 40 conducts current through solenoid coil 42 in one direction to shift valve 22 into an open or flow-enable position. In response to a valve-close signal from IC 26, circuit 40 conducts current through solenoid coil 42 in an opposite direction to shift valve 22 into a closed or flow-disable position.

Sampling IC 28 is provided on an input side with an amplification and signal stabilization subcircuit 44 connected to receiving transducer RX. Amplification and signal stabilization subcircuit 44 includes an amplifying transistor Q7 and signal-stabilizing transistors Q8 and Q9 (all parts #9014C). Amplification and signal stabilization subcircuit 44 further includes a 100 μF capacitor C8 and the following resistors connected to transistors Q7, Q8, and Q9 in the illustrated configuration: a 10 kΩ resistor R14, another 10 kΩ resistor R15, a 20 kΩ resistor R16, a 3.3 MΩ resistor R17, a 2 kΩ resistor R18, a 1 kΩ resistor R19, a 910 Ω resistor R20. Amplification and signal stabilization subcircuit 44 is connected to secondary IC 28 via a 0.01 μF capacitor C5, a 0.001 μF capacitor C6, and a 0.047 μF capacitor C7. Voltage VCC is between 2.2 and 4.5 volts.

Sampling IC 28 is additionally connected to a decoding and amplifying subcircuit 46 including a transistor Q6 (part 9014C), a first capacitor C3 (10 μF), a second capacitor C4 (0.1 μF), a 100 Ω resistor R12, and a 10 kΩ resistor R13, all connected to IC 26 and IC 28 as depicted in FIG. 4. Sampling IC 28 is further provided with a subcircuit 48 for enabling an adjustment in the frequency of the sampling IC 26 to match the 40 kHz frequency of the ultrasonic detection signal emitted by transmitting transducer TX of sensor 18. Subcircuit 48 includes a 0.01 μF capacitor C2, a 2 kΩ resistor R10, and a 1 kΩ variable resistor RV. Primary circuit 26 and sampling circuit IC 28 receive voltage VDD via a 10 kΩ resistor R11.

Sampling IC 28 and its associated circuits 44, 46, and 48 provide a signal to primary IC 26 upon the reception of a 40 kHz signal by sensor transducer RX. If the signal from transducer RX indicates that an object has been placed in a sink between the sink bottom and sensor 18, primary IC 26 transmits a signal to valve activation subcircuit 40 via resistor R7, causing solenoid 42 to open valve 22 and thereby permit water flow from inlet port 14 to outflow port 16.

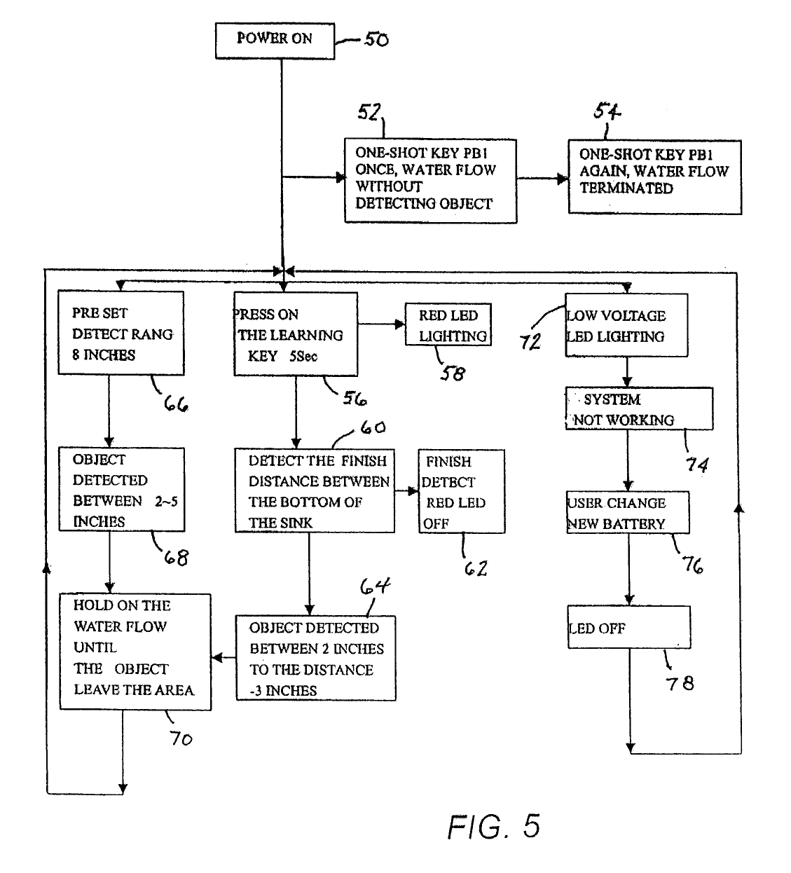

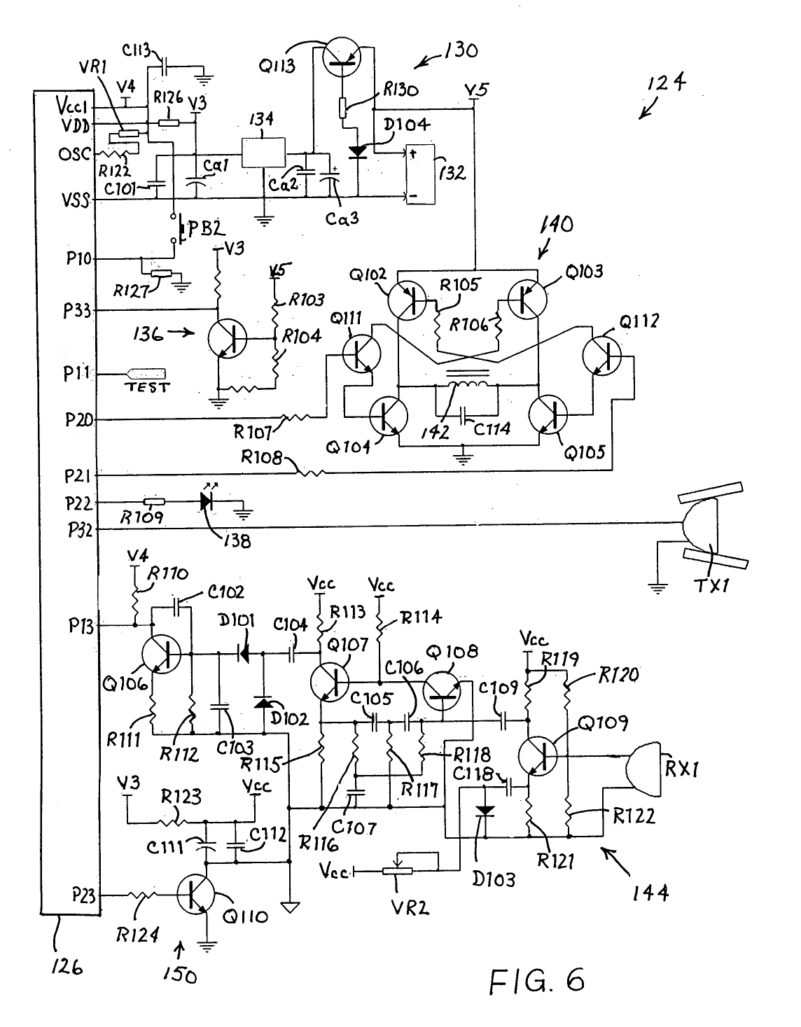

FIG. 5 depicts steps in the operation of primary IC 26. The operations of FIG. 5 are executed after the installation of the water-flow control or gating device on a sink spigot or spout. Once power has been turned on in a step 50, IC 26 conducts a query 52 as to whether a manual switch PB1 (FIG. 4) has been briefly closed. A quick actuation of switch PB1 by a user induces primary IC 26 to override the automatic valve control process and to open valve 22. More specifically, in response to a closure of switch PB1 for less than five seconds, IC 26 transmits a valve-open signal to valve activation circuit 40. After the initiation of a manual override, primary IC 26 continues to monitor switch PB1 in a step 54. Upon detecting another brief closure of switch PB1, IC 26 transmits a valve-close signal to valve activation subcircuit 40, thereby resulting in a closure of valve 22 by solenoid 42.

In carrying out a further inquiry 56, primary IC 26 monitors switch PB1 for a closure lasting more than 5 seconds. If such a closure is detected, primary IC transmits an energization signal to LED 38 in a step 58 to induce the diode to generate light of a selected intensity, for indicating the execution of a learning or calibration procedure by control circuit 26. In another step 60, primary IC 26 induces transducer TX to emit a test pulse and monitors input from sampling IC 28 and its associated circuits 44, 46, and 48 to determine the time that a reflected pulse is detected via transducer RX after the emission of the test pulse. The measured time interval is proportional to the distance to the bottom of the sink in which the gating device has been installed.

After the measurement of the return pulse time interval and thus the distance to the sink bottom, primary IC 26 terminates the detection procedure and the signal to LED 38 in a step 62. The learning or calibration procedure includes a further step 64 during which primary IC calculates a range of pulse return times or distances that, if detected during normal operation, results in an opening of valve 22. Thus if an object is inserted into the sink at a distance or location within the calculated range, primary IC transmits a valve-open signal to valve activation circuit 40, causing valve 22 to permit water flow from inlet port 14 to outflow port 16. Where a sink is, for example, 8 inches deep (e.g., as measured from the bottom side of the installed gating device), a valve activation range might extend from 2 inches to 5 inches below the installed gating device.

In another step 66, primary IC periodically transmits ultrasonic test or scan pulses of 40 kHz into the sink via transducer TX and monitors incoming ultrasonic signals to determine whether an object has been inserted into the sink. If in a step 68 primary IC 26 detects such an object between the 2-inch minimum distance and the 5-inch maximum distance from the gating device (for instance, from outflow port 16), primary IC 26 causes valve activation subcircuit 40 to open valve 22. In a step 70, primary IC 26 periodically energizes transducer TX and monitors incoming signals as sampled by IC 28. Primary IC 26 maintains water flow as long as the object is still located in the sink between the previously calculated minimum and maximum distances. Once the object is removed from the sink, and particularly from the range of valve activation locations, IC 26 terminates the signal to valve activation subcircuit 40, resulting in closure of valve 22 a few seconds after the object has been removed from the sink.

In another step 72, primary IC 26 voltage supply subcircuit 30 to check the power level provided by batteries 32 and 34. Upon detecting in a step 74 that one or both batteries 32 and 34 are providing insufficient power for proper circuit operation, IC 26 causes LED 38 to emit a different kind of light signal to communicate to the user that the batteries need replacement. In a step 76, primary IC 26 detects that a battery change has occurred and terminates the alert signal to LED 38 (step 78).

As depicted in FIG. 6, an alternative control circuit 124 comprises a primary integrated circuit (IC) 126 that specifically takes the form of EMC chip No. PM0242. Primary IC 126 controls learning functions (determination of sink size), indicator activation and valve operation. Primary IC 126 also enables a manual bypass or override of the automatic flow control.

Control circuit 124 further comprises a voltage supply subcircuit 130 including a set of four 1.5-volt batteries 132, a transistor Q113 (part 38550D), and a secondary IC chip 134. IC 134 may specifically realized by Holtek part No. HT7144 and functions to provide a stable voltage to primary IC 126. Secondary IC 134 is connected to a filtering network 135 including a 0.1 μF capacitor C101, a 100 μF capacitor Ca1 (10V maximum voltage), a 0.1 μF capacitor Ca2, and a 100 μF capacitor Ca3 (10V maximum voltage). Transistor Q113 is connected to battery 132, secondary IC 134 and filtering network 135 in the illustrated configuration, with the base of the transistor grounded via a 68 kΩ resistor R130 and a diode D104 (part 4148).

Voltage supply subcircuit 130 further includes a 51 Ω resistor R126, a 0.1 μF capacitor C113, and a 91 kΩ (+1%) resistor R122, and a variable resistor VR1 connected in the illustrated structure to terminals vcc1, VDD, OSC and VSS of primary IC 126. Variable resistor R123 is adjustable to modify the operating frequency of the ultrasonic sensor. Voltage supply circuit 130 provides a first voltage V3 of 4.4 volts, a second voltage V4 of about 4.4 volts, a third voltage V5 of 6.0 volts.

Capacitor C113 is connected via resistors R122 and R123 to an oscillator input OSC of IC 126, for enabling the generation of a variable waveform nominally 40 KHz fed to an electroacoustic transducer TX1. Transducer TX1 is a transmitting part of sensor 18 and incorporates a piezoelectric crystal. Sensor 18 further includes a receiving transducer RX1 that also incorporates a piezoelectric crystal.

Control circuit 124 also comprises a voltage monitoring subcircuit 136 operatively connected to voltage supply circuit 130 via IC 126 for monitoring the power level of at least battery 132. Subcircuit 130 includes a transistor Q101 (part #9014C) and resistors R102, R103, R104, and R104′ of 100 kΩ, 1 MΩ, 120 kΩ (±1%), and 15 kΩ (±1%), respectively. In response to a signal from subcircuit 136, primary IC 126 energizes a light-emitting diode (LED) 138 via a 1 kΩ resistor R109 with a predetermined waveform (e.g., pulsating) to indicate a battery-weak condition.

Control circuit 126 additionally comprises a valve activation subcircuit 140 including a first pair of transistors Q102 and Q103 (parts #8550D) and a second pair of transistors Q104 and Q105 (parts #8050D) connected to a solenoid coil 142 in a bridge configuration including a 470 Ω resistor R105 and a 100 Ω resistor R106 and two additional transistors Q111 and Q112 (parts 9014C). The base of transistor Q111 is connected to an a valve-open pin or terminal P20 of primary IC 126 via a 1 kΩ resistor R107, while a base of transistor Q112 is connected to a valve-close pin or terminal P21 of primary IC 126 via another 1 kΩ resistor R108. A 1 μF capacitor C114 is coupled across solenoid coil 142.

Valve activation circuit 140 is connected to voltage supply subcircuit 130 for receiving voltage V5. In response to a valve-open signal from pin P20 of primary IC 126, circuit 140 conducts current through solenoid coil 142 in one direction to shift valve 22 into an open or flow-enable position. In response to a valve-close signal from pin P21 of primary IC 26, circuit 140 conducts current through solenoid coil 142 in an opposite direction to shift valve 22 into a closed or flow-disable position. Transistors Q111 and Q112 serve to amplify the valve-open and valve-close signals from primary IC 126.

Control circuit 124 further includes an amplification and signal stabilization subcircuit 144 connected to receiving transducer RX1. Amplification and signal stabilization subcircuit 144 includes an amplifying transistor Q109 (part #9014C) and attendant circuit elements, namely, a 4.7 kΩ resistor R119, a 200 kΩ resistor R120, a 1 kΩ resistor R121, a 68 kΩ resistor R122, a 0.1 μF capacitor C110, and a 103 capacitor C109, as well as a variable 1 kΩ resistor VR2 and a diode D103 (part 4148).

Amplification and signal stabilization subcircuit 144 further includes transistors Q106, Q107, and Q108 and an ancillary circuit network that functions to further amplify the incoming ultrasonic signals and to convert the waveform to a flat consistent signal for submission to primary IC 126. The ancillary network includes, in the illustrated configuration, a 20 kΩ resistor R110, a 300 pF capacitor C102, a 1 kΩ resistor R111, a 30 kΩ resistor R112, a 300 pF capacitor C103, a 103 F capacitor C104, diode D101 and D102 (parts 4148), a 3 kΩ resistor R113, a 100 kΩ resistor R114, four resistors R115, R116, R117, R118 respectively of 1 kΩ, 39 kΩ, 20 kΩ, and 39 kΩ, and three capacitors C105, C106, and C107 respectively of 100 pF, 100 pF, and 200 pF. Voltage Vcc is between 2.2 and 4.5 volts.

Control circuit 124 further includes a power switch subcircuit 150 including a transistor Q10 (part 9014C), a 100 Ω resistor R123, a 47 μF capacitor C111, a 104 F capacitor C112, and a 1 kΩ resistor R124. When transistor Q110 is conducting, transistors Q106-Q109 are operative. When transistor Q110 is non-conducting, transistors Q106-Q109 are off, for power saving purposes.

Transistors Q106-Q109 and their associated circuitry provide a signal to primary IC 126 upon the reception of an ultrasonic signal by sensor transducer RX1. If the signal from transducer RX1 indicates that an object has been placed in a sink between the sink bottom and sensor 18, primary IC 126 transmits a signal to valve activation subcircuit 140 via resistor R107, causing solenoid 142 to open valve 22 and thereby permit water flow from inlet port 14 to outflow port 16.

Control circuit 124 includes a manual switch PB2 connected to a pin P10 of primary IC 126 and to ground via a 7.5 kΩ resistor R127. A quick actuation of switch PB3 by a user induces primary IC 126 to override the automatic valve control process and to open valve 22. More specifically, in response to a closure of switch PB2 for less than five seconds, IC 126 transmits a valve-open signal to valve activation circuit 140. After the initiation of a manual override, primary IC 126 continues to monitor switch PB2. Upon detecting another brief closure of switch PB2, IC 126 transmits a valve-close signal to valve activation subcircuit 140, thereby resulting in a closure of valve 22 by solenoid 42.

Although the invention has been described in terms of particular embodiments and applications, one of ordinary skill in the art, in light of this teaching, can generate additional embodiments and modifications without departing from the spirit of or exceeding the scope of the claimed invention. For example, various ancillary features may be added to a faucet or spigot assembly including a remote control device as described hereinabove. Such features may include a filter (not shown) removably attachable to outflow port 16, as well as a temperature sensor and a temperature indicator such as an LCD display for informing a user as to water temperature. In addition, the configuration of the water flow gating device as shown in FIGS. 1-3 is arbitrary and may be changed without affecting the function of the device. For instance, the location of the battery compartment and cover 20 may be on the underside of the casing rather than on a side panel.

Accordingly, it is to be understood that the drawings and descriptions herein are proffered by way of example to facilitate comprehension of the invention and should not be construed to limit the scope thereof.

1. A water flow gating device, comprising:
a casing;
an inlet port disposed on said casing and couplable to a faucet spout;
a water outflow port on said casing;
a valve disposed in said casing between said inlet port and said outflow port for controlling water flow from said inlet port to said outflow port;
an ultrasonic sensor mounted to said casing; and
a control circuit operatively connected to said sensor and said valve to control opening and closing of said valve in accordance with signals received from said sensor.

2. The gating device defined in claim 1 wherein said control circuit includes means for calibrating the gating device in accordance with sink size.

3. The gating device defined in claim 2, further comprising a battery in said casing, said control circuit including means for indicating a low power condition of said battery.

4. The gating device defined in claim 3 wherein said means for indicating includes an electro-optical transducer and a circuit for energizing said transducer to emit a predetermined alert signal.

5. The gating device defined in claim 2 wherein said means for calibrating includes means for determining a distance to a surface.

6. The gating device defined in claim 5 wherein said means for calibrating further includes means for calculating a range of object distances for faucet activation.

7. The gating device defined in claim 1 wherein said control circuit includes a power level detection subcircuit.

8. The gating device defined in claim 1 wherein said control circuit includes means for detecting distance to an object.

9. The gating device defined in claim 1 wherein said control circuit includes a manual override.

10. A method for controlling water flow from a faucet spout, comprising:
connecting a modular flow control device to an outlet of said faucet spout;
operating an ultrasonic sensor on said device to monitor a space between said control device and an underlying sink surface; and
upon detecting an object between said control device and said sink surface, operating a valve to permit water from said outlet to an outflow port on said control device.

11. The method defined in claim 10, further comprising calibrating said control device in accordance with sink size.

12. The method defined in claim 11 wherein the calibrating of said control device includes operating said control device to detect a distance between said control device and said sink surface.

13. The method defined in claim 12 wherein the calibrating of said control device further includes operating a programmed circuit in said control device to compute a minimum distance and a maximum distance of an operating range, the detecting of an object between said control device and said sink surface including detecting said object within said operating range.

14. A water flow gating device comprising:
a casing;
an inlet port disposed on said casing and couplable to a water faucet outlet;
a water outlet on said casing; a valve disposed in said casing between said inlet port and said outlet for controlling water flow from said inlet port to said outlet;
an ultrasonic sensor mounted to said casing;
a control circuit operatively connected to said sensor and said valve to control opening and closing of said valve in accordance with signals received from said sensor; and
a battery disposed in said casing and operatively connected to said control circuit,
said control circuit including means for detecting a low power condition of said battery,
said control circuit including a manual override,
said control circuit further including means for calibrating the gating device in accordance with sink size.

15. The gating device defined in claim 14, further comprising a transducer operatively connected to said control circuit for indicating a low power condition of said battery.

16. The gating device defined in claim 14 wherein said means for calibrating includes means for determining a distance to a surface.

17. The gating device defined in claim 14 wherein said means for calibrating includes means for calculating a range of object distances for faucet activation.
